(19) United States
(12) Patent Application Publication
(10) Pub. No.: US 2015/0248734 A1
(43) Pub. Date: Sep. 3, 2015

(54) DISPLAYING ACTIVITY STREAMS FOR PEOPLE AND GROUPS IN AN ENTERPRISE

(71) Applicant: Microsoft Corporation, Redmond, WA (US)

(72) Inventors: Viral Shah, Oslo (NO); Bjørn Olstad, Stathelle (NO); Helge Grenager Solheim, Oslo (NO); Vikramjeet Singh Jassal, Lørenskog (NO); Berit Herstad, Oslo (NO)

(73) Assignee: MICROSOFT CORPORATION, Redmond, WA (US)

(21) Appl. No.: 14/194,638

(22) Filed: Feb. 28, 2014

(51) Int. Cl. G06Q 50/00; G06Q 10/06

(52) U.S. Cl. CPC G06Q 50/01; G06Q 10/063114

(57) ABSTRACT

An activity stream for an individual or group of individuals across multiple workloads comprising activity data may be provided. Activity data may include various types of data/information received from a variety of information sources. Received activity data may be stored, and an activity stream for an individual or group of individuals may be generated. A timeline view may be generated for each activity stream. Upon request, the timeline view for a given individual or group of individuals (grouped according to any desired grouping) may be presented in a user interface to allow a requesting user to view activity data/information for the given individual or group of individuals.

### BACKGROUND

In a workplace, individuals are oftentimes connected through formalized groups as well as through activities across a variety of workloads. For example, individuals may share a relationship according to an organizational structure (e.g., peers, managers, directs, etc.). Additionally, individuals may interact with a variety of content (e.g., documents, emails, webpages, etc.) that are connected with other individuals. For example, an individual may provide feedback on a document created by another individual by “liking” the document via a social media workload. Another individual may comment on the document via another social media workload.

While a user may be able to go to a specific service to see activities related to an individual or entity on a specific workload, it is oftentimes difficult for users to get an overview of an individual's or a group's activities across multiple workloads. It is with respect to these and other considerations that the present invention has been made.

### SUMMARY

This summary is provided to introduce a selection of concepts in a simplified form that are further described below in the detailed description. This summary is not intended to identify key features or essential features of the claimed subject matter, nor is it intended as an aid in determining the scope of the claimed subject matter.

Embodiments of the present invention solve the above and other problems by providing an information or activity stream for an individual or group of individuals. Activity data may include various types of information such as, but not limited to, presence data, data associated with authoring or modification of a document, trending data, feedback data (e.g., like, comment, follow, share, etc.), data associated with organizational structure (e.g., who an individual works with, works for, interacts with, is a peer to, directs, manages, is managed by, has in common with another individual, etc.). Activity data for an individual or group of individuals may be received from a variety of information sources including, but not limited to, social networking services, enterprise social network services, online productivity application and software services, collaboration services, communication software, etc. Received activity data may be stored, and a timeline view may be generated for each individual or group of individuals. Upon request, the timeline view for a given individual or group of individuals (grouped according to any desired grouping) may be presented in a user interface to allow a requesting user to view activity data/information for the given individual or group of individuals.

The details of one or more embodiments are set forth in the accompanying drawings and description below. Other features and advantages will be apparent from a reading of the following detailed description and a review of the associated drawings. It is to be understood that the following detailed description is explanatory only and is not restrictive of the invention as claimed.

### BRIEF DESCRIPTION OF THE DRAWINGS

The accompanying drawings, which are incorporated in and constitute a part of this disclosure, illustrate various embodiments of the present invention. In the drawings:

FIG. 1 is a block diagram of one embodiment of a system for providing an activity stream across multiple workloads;

FIGS. 2A and 2B are examples user interfaces comprising an activity stream for an individual;

FIG. 3 is a flow chart of a method for providing an activity stream across multiple workloads;

FIG. 4 is a block diagram illustrating example physical components of a computing device with which embodiments of the invention may be practiced;

FIGS. 5A and 5B are simplified block diagrams of a mobile computing device with which embodiments of the present invention may be practiced; and

FIG. 6 is a simplified block diagram of a distributed computing system in which embodiments of the present invention may be practiced.

### DETAILED DESCRIPTION

Embodiments of the present invention are directed to providing an activity stream across multiple workloads. As briefly summarized above, activity data may include various types of data/information received from a variety of information sources. Received activity data may be stored, and an activity stream for an individual or group of individuals may be generated. A timeline view may be generated for each activity stream (for an individual or group of individuals). Upon request, the timeline view for a given individual or group of individuals (grouped according to any desired grouping) may be presented in a user interface to allow a requesting user to view activity data/information for the given individual or group of individuals.

The following detailed description refers to the accompanying drawings. Wherever possible, the same reference numbers are used in the drawing and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention, but instead, the proper scope of the invention is defined by the appended claims.

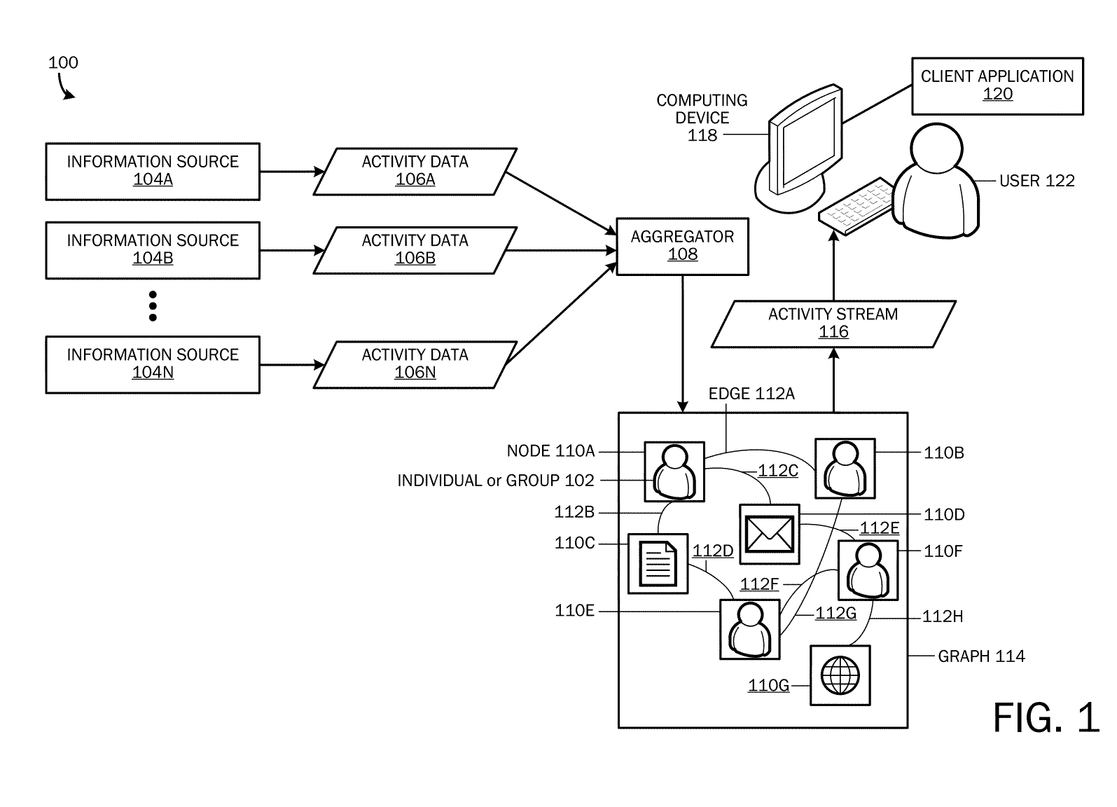

Referring now to the drawings, in which like numerals represent like elements, various embodiments will be described. FIG. 1 is a block diagram illustrating a system architecture 100 for providing an activity stream across multiple workloads. The system architecture 100 includes an aggregator 108 operable to collect activity data 106A-N (collectively 106) for an individual 102 or group of individuals from a plurality of workloads or information sources 104A-N(collectively 104) and store the activity data 106 in a graph 114. The information sources 104 (sometimes described herein as workloads) may include various types of information sources such as social networking services, enterprise social network services, online productivity software service, collaboration services, communication software, etc.

Activity data 106 may comprise various types of information such as, but not limited to, presence data, data associated with authoring or modification of a document, trending data, feedback data (e.g., like, comment, follow, share, etc.), data associated with organizational structure (e.g., who an individual works with, works for, interacts with, is a peer to, directs, manages, is managed by, has in common with another individual, etc.). As mentioned above, the activity data 106 may be stored in a graph 114. Actions may be stored as edges 112A-H (collectively 112), and entities that are acted upon may be stored as nodes 110A-G (collectively 110). For example, a node 110 may include an individual 102 (nodes 110A,B,E,F), a group of individuals, a document (node 110C), an email or other communication type (node 110D), a webpage (node 110G), etc. An edge 112 may include various types of actions (e.g., like, comment, follow, share, authoring, modifying, organizational relationship, communication, participation, etc.). Consider for example that an individual 102 “likes” a certain document (i.e., selects a “like” option associated with the document). The individual and the document may be stored as nodes 110 and the “like” selection may be stored as an edge 112.

A user 122 may selectively view enterprise activity for an individual 102 or group. According to embodiments, a group may be a formalized set of individuals according to an organizational hierarchy or project structure, or may be a less formally coupled set of individuals such as a group of individuals who are common attendees of a particular meeting, a project group, a group of individuals who share a common interest in a particular topic, etc. An individual 102 may be a part of a plurality of groups. The user 122 may utilize a client application 120 on a computing device 118 to request an activity stream 116. According to one embodiment, a request may be triggered via navigation to or selection of a representation of an individual 102 or group from a user interface, for example, a user interface displayed on computing device 118 via client application 120.

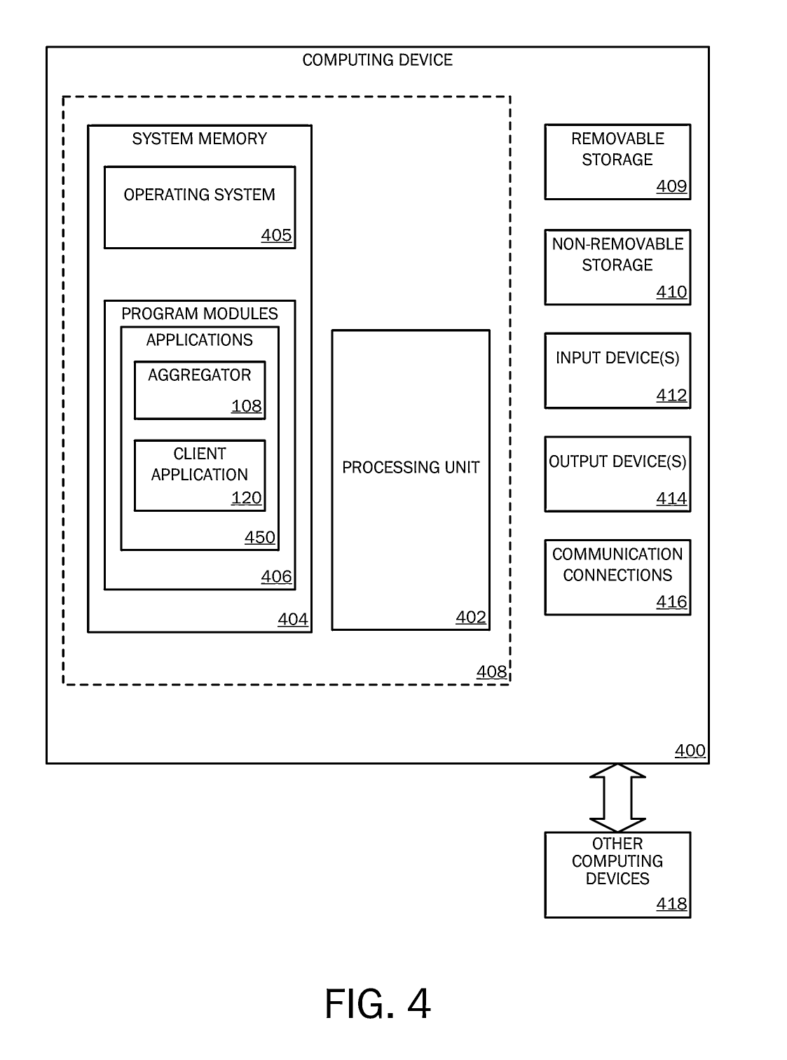

The computing device 118 may be one of a variety of suitable computing devices described below with reference to FIGS. 4 through 6. For example, the computing device 118 may include a tablet computing device, a desktop computer, a mobile communication device, a laptop computer, a laptop/tablet hybrid computing device, a gaming device, or other type of computing device for executing applications 120 for performing a variety of tasks.

The application 120 illustrated in association with computing device 118 is illustrative of any application having sufficient computer executable instructions for enabling embodiments of the present invention as described herein. The application 120 may include a thick client application, which may be stored locally on the computing device 118, or may include a thin client application (i.e., web application) that may reside on a remote server and accessible over a network, such as the Internet or an intranet. A thin client application may be hosted in a browser-controlled environment or coded in a browser-supported language and reliant on a common web browser to render the application executable on a computing device 118.

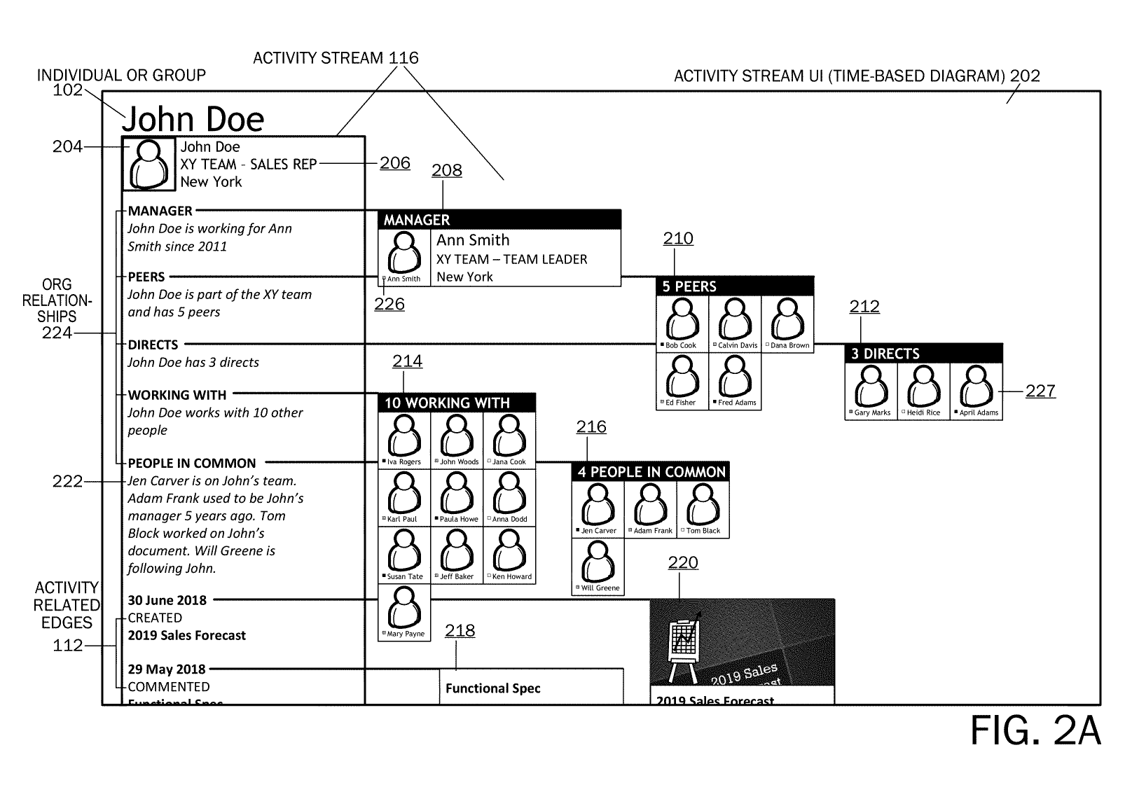

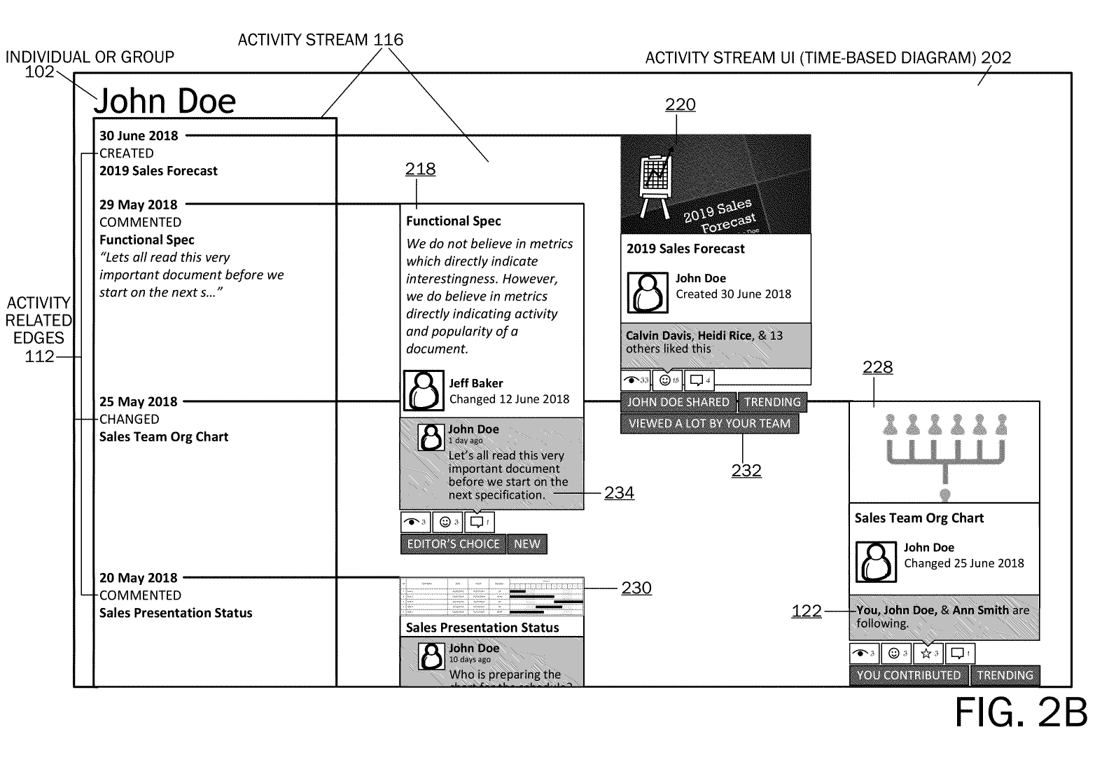

When a request for an activity stream 116 for an individual 102 or a group is received, the graph 114 may be parsed for the particular individual 102 or group, actions of the individual 102 or group (stored as edges 112), and entities that were acted upon (stored as nodes 110). The request for an activity stream 116 may be a search API, and may comprise authorization information for determining what content the user 122 has been granted access to receive. A response may be generated and may comprise an activity stream 116 of activity (associated with the individual 102 or group) to which the user 122 has been granted access. The activity stream 116 may be provided to the client application 120 and displayed in a user interface that will be described in detail with reference to FIGS. 2A and 2B. As mentioned above, an individual 102 may be a part of a plurality of groups. According to one embodiment, a single activity feed across all groups an individual is part of may be displayed in the user interface. According to another embodiment, an activity feed for each group an individual is a part of may be displayed separately.

Referring now to FIG. 2A, an example activity stream user interface 202 is illustrated that may be displayed on any suitable computing device 118 described above. According to embodiments, user interaction with the activity stream user interface 202 may be accomplished via a variety of interaction methods including keyboard entry, mouse entry, gesture entry, voice command, eye tracking, thin air gesture entry, electronic inking entry, and/or combinations thereof. The example activity stream user interface 202 may comprise a name of the individual 102 or group and may comprise a picture, avatar, or other visual representation 204 of the individual 102 or group. Other information 206 such as a team the individual 102 or group is a part of, the individual's job title, a biography, etc., may also be displayed.

According to embodiments, organizational relationships 224 (e.g., directs 212, peers 210, managers 208, working with 214, people an individual 102 and a user 122 have in common 216, etc.) associated with a given individual 102 or group may be provided. A display of organizational relationships 224 may also comprise information such as a number of people an individual 102 or an individual in a group is a peer to, works with, directs, etc. Other information may also be provided such as a length of time the individual 102 has worked with or for another person, a description 222 of how people in common 216 with the individual (and the user 122) share a commonality, etc. A display of representations of the people who the individual 102 or group has an organizational relationship 224 with (e.g., directs 212, peers 210, managers 208, working with 214, people in common 216 with the user 122, etc.) may comprise one or more of a photo, image, avatar, or other type of visual representation, a name, and a presence indicator 226 of each person, and may be provided in selectable panes 227. If a pane 227 associated with a person is selected, the activity stream user interface 202 may be refreshed with the activity stream 116 of the selected person. For example, if a user 122 selects the pane 227 associated with April Adams, April's activity stream 116 may be displayed in the activity stream user interface 202.

According to embodiments, a display of activity-related edges 112 for the individual 102 or group may also be provided in the activity stream user interface 202 as illustrated at the bottom of FIG. 2A and in FIG. 2B. As illustrated, the activity stream user interface 202 may be scrollable. For example, the activity stream user interface 202 displayed in FIG. 2B comprises a scrolled-down portion of the activity stream 116 illustrated in FIG. 2A. With reference now to FIG. 2B, a time-based display of activity-related edges 112 and the documents 218,220,228,230 acted on by the individual 102 or group in focus may be provided in the activity stream user interface 202. In additional to displaying activity for a given individual 102 or group, a user 122 may be provided with an option to view all activity for people who share an organizational relationship (e.g., directs, peers, managers, etc.) with the individual 102.

In a timeline view, a listing of the activity-related edges 112 may be displayed in order starting with a most recent activity. According to an embodiment, the activity-related edges 112 may be spaced according to a time relationship. For example, the first two displayed activity-related edges 112 occurred within a day of each other and are spaced closely together in contrast to the next displayed activity-related edge which is shown to have occurred four days later and accordingly is spaced further down in the time-based display.

Also as illustrated, the documents 218,220,228,230 acted on by the individual 102 or group in focus may be visually represented by a thumbnail image of the item, and may include information such as the item's author, a last modification date of the item, other individuals who have interacted with the item and their activity, a number of views, likes, comments, followers, etc. If document 218,220,228,230 has been commented on, the comment 234 may be displayed as illustrated with respect to document 218. Additional information such as insights 232 gleaned from activity-related edges 112 may be included. For example, with respect to document 220, three insights 232 are displayed: “John Doe shared,” “trending,” and “viewed a lot by your team.” A trending insight may be determined according to an amount of interaction with a document by an individual 102 or group and/or by other people associated with the individual or group (e.g., associated by organizational relationship, etc.). Accordingly, a user 122 may be able to see what items may be trending or popular around him/her. The insights 232 may provide relevant and useful information to the user 122.

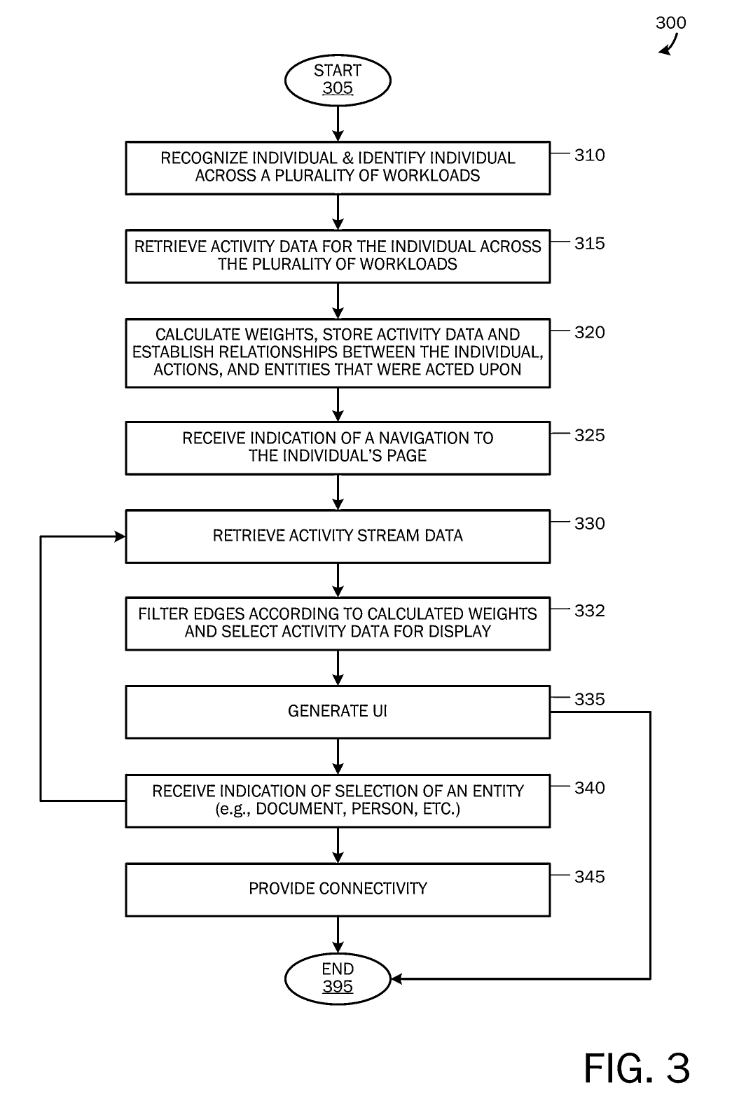

FIG. 3 is a flow chart showing one embodiment of a method 300 for providing an activity stream across multiple workloads. The method 300 starts at OPERATION 305 and proceeds to OPERATION 310, where an individual 102 or group is recognized and identified across a plurality of workloads (information sources 104). As described above, information sources 104 may include various types of information sources such as social networking services, enterprise social network services, online productivity software service, collaboration services, communication software, etc. According to an embodiment, OPERATION 305 may include a set-up process where the individual 102 or group may indicate which information sources 104 to utilize for providing activity information and may enter authentication information for the various information sources 104. OPERATION 305 may also include a creation of a group. For example, creation of a group may be triggered by creation of a meeting event wherein participants of the meeting event may be classified as a group.

The method 300 may proceed to OPERATION 315, where activity data 106 for the individual 102 or group may be received from one or more of the plurality of information sources 104. The activity data 106 may be pushed to the aggregator 108, or may be retrieved from the information sources 104. As described above, activity data 106 may comprise various types of information such as, but not limited to, presence data, data associated with authoring or modification of a document, trending data, feedback data (e.g., like, comment, follow, share, etc.), data associated with organizational structure (e.g., who an individual works with, works for, interacts with, is a peer to, directs, manages, is managed by, has in common with another individual, etc.).

At OPERATION 320, the activity data 106 may be stored in a graph 114 as nodes 110 and edges 112. That is, the activity data 106 may be analyzed, and relationships may be established between the individual 102 or group, activities, and entities (e.g., documents 218,220,228,230, emails, webpages, etc.) upon which an activity was performed. According to embodiments, the activity data 106 may be analyzed, and weights may be calculated according to the type of activity performed. For example, an edit or share activity may be weighted higher than a like activity. The weights may be stored with the activity-related edges 112.

At OPERATION 325, an indication of a selection of or navigation to the individual's 102 or group's page may be received. For example, the individual's 102 or group's pane 227 displayed in an activity stream user interface 202 may be selected by a user 122.

The method 300 may proceed to OPERATION 330, where the selected individual's 102 or group's activity (i.e., activity stream 116) may be retrieved from the graph 114. At OPERATION 332, a determination may be made as to which activities to display. The individual's activity-related edges 112 may be ranked and filtered according to their calculated weights, and the most relevant activities amongst a potentially large amount of activities may be selected for display in the individual's or group's activity stream 116.

At OPERATION 335, an activity stream user interface 202 may be generated for displaying the individual's 102 or group's activity stream 116, for example, as illustrated and described above with reference to FIGS. 2A and 2B. The activity stream 116 may be displayed and may comprise organizational relationships 224 (e.g., directs 212, peers 210, managers 208, working with 214, people the individual 102 or group and the user 122 have in common 216, etc.), activity-related edges 112, as well as a display of documents 218,220,228,230 and other entities acted upon by the individual 102 or group. The activity-related edges 112 may be displayed in a timeline view, wherein a timeline view comprises displaying the activity-related edges 112 in time order starting with a most recent activity. As described above, the activity-related edges 112 may be spaced according to a time relationship.

At OPERATION 340, an indication of a selection of an entity (e.g., a person, a document 218,220,228,230, etc.) displayed in the individual's 102 or group's activity stream 116 may be received. If a person is selected from the individual's 102 or group's activity stream 116, the method 300 may return to OPERATION 330 to retrieve an activity stream 116 for the selected person. If a document 218,220,228,230 or other type of entity is selected, the method 300 may proceed to OPERATION 345, where connectivity to the selected entity may be provided. For example, if a document 218,220,228,230 is selected, the document may be opened in an appropriate application for the selected document (e.g., a presentation may be opened in a slide presentation application). The method may end at OPERATION 395.

While the invention has been described in the general context of program modules that execute in conjunction with an application program that runs on an operating system on a computer, those skilled in the art will recognize that the invention may also be implemented in combination with other program modules. Generally, program modules include routines, programs, components, data structures, and other types of structures that perform particular tasks or implement particular abstract data types.

The embodiments and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In addition, the embodiments and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

FIGS. 4-6 and the associated descriptions provide a discussion of a variety of operating environments in which embodiments of the invention may be practiced. However, the devices and systems illustrated and discussed with respect to FIGS. 4-6 are for purposes of example and illustration and are not limiting of a vast number of computing device configurations that may be utilized for practicing embodiments of the invention, described herein.

FIG. 4 is a block diagram illustrating physical components (i.e., hardware) of a computing device 400 with which embodiments of the invention may be practiced. The computing device components described below may be suitable for the client device 118 described above. In a basic configuration, the computing device 400 may include at least one processing unit 402 and a system memory 404. Depending on the configuration and type of computing device, the system memory 404 may comprise, but is not limited to, volatile storage (e.g., random access memory), non-volatile storage (e.g., read-only memory), flash memory, or any combination of such memories. The system memory 404 may include an operating system 405 and one or more program modules 406 suitable for running software applications 450 such as the aggregator 108 or client application 120. The operating system 405, for example, may be suitable for controlling the operation of the computing device 400. Furthermore, embodiments of the invention may be practiced in conjunction with a graphics library, other operating systems, or any other application program and is not limited to any particular application or system. This basic configuration is illustrated in FIG. 4 by those components within a dashed line 408. The computing device 400 may have additional features or functionality. For example, the computing device 400 may also include additional data storage devices (removable and/or non-removable) such as, for example, magnetic disks, optical disks, or tape. Such additional storage is illustrated in FIG. 4 by a removable storage device 409 and a non-removable storage device 410.

As stated above, a number of program modules and data files may be stored in the system memory 404. While executing on the processing unit 402, the program modules 406 may perform processes including, but not limited to, one or more of the stages of the method 300 illustrated in FIG. 3. Other program modules that may be used in accordance with embodiments of the present invention and may include applications such as electronic mail and contacts applications, word processing applications, spreadsheet applications, database applications, slide presentation applications, drawing or computer-aided application programs, etc.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. For example, embodiments of the invention may be practiced via a system-on-a-chip (SOC) where each or many of the components illustrated in FIG. 4 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to providing an activity stream across multiple workloads may be operated via application-specific logic integrated with other components of the computing device 400 on the single integrated circuit (chip). Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

The computing device 400 may also have one or more input device(s) 412 such as a keyboard, a mouse, a pen, a sound input device, a touch input device, etc. The output device(s) 414 such as a display, speakers, a printer, etc. may also be included. The aforementioned devices are examples and others may be used. The computing device 400 may include one or more communication connections 416 allowing communications with other computing devices 418. Examples of suitable communication connections 416 include, but are not limited to, RF transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 404, the removable storage device 409, and the non-removable storage device 410 are all computer storage media examples (i.e., memory storage.) Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 400. Any such computer storage media may be part of the computing device 400. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

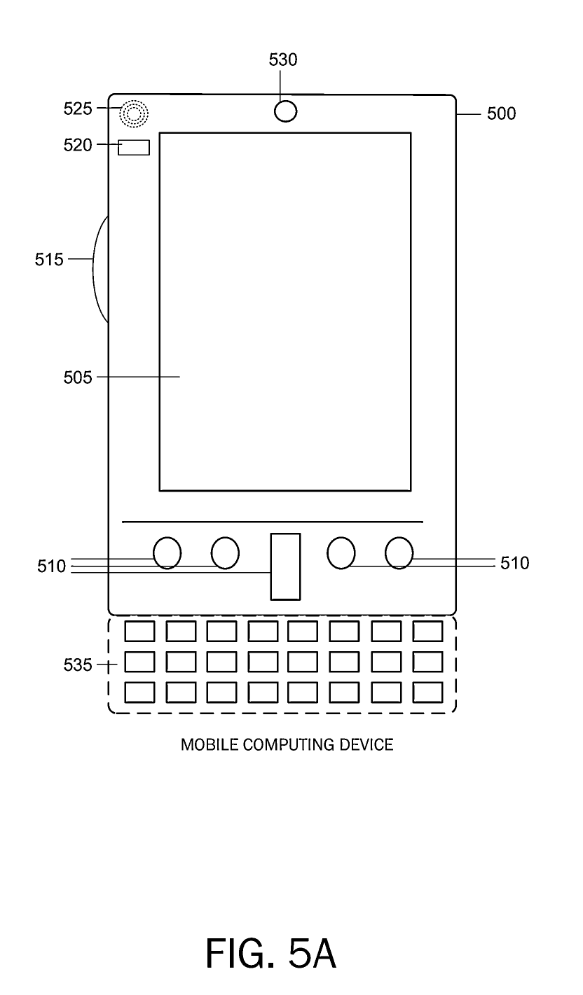

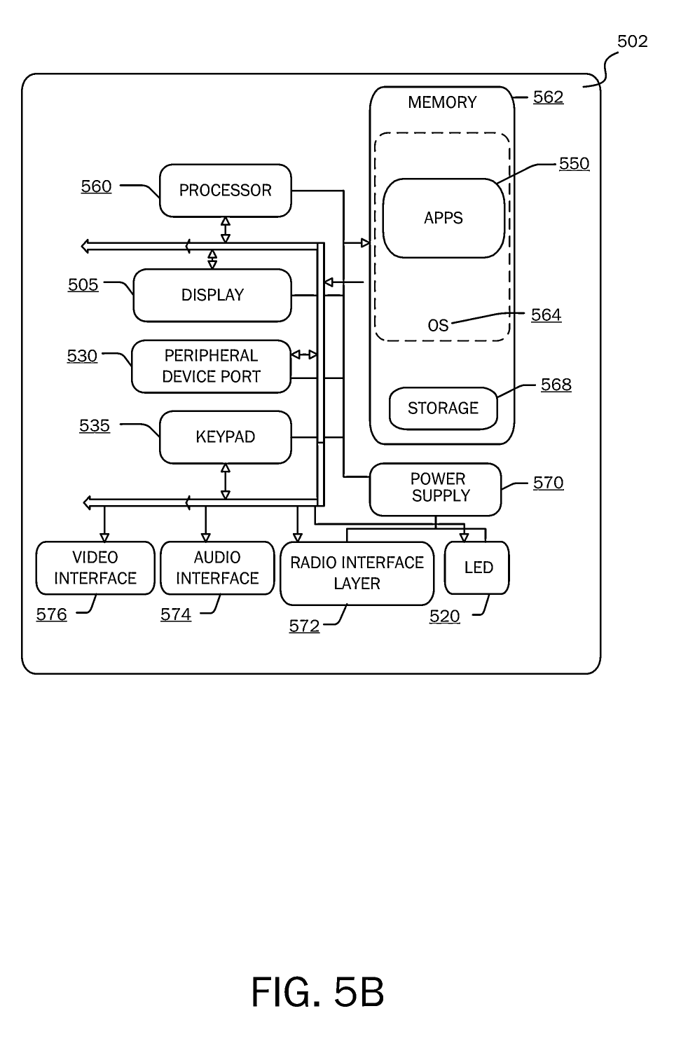

FIGS. 5A and 5B illustrate a mobile computing device 500, for example, a mobile telephone, a smart phone, a tablet personal computer, a laptop computer, and the like, with which embodiments of the invention may be practiced. With reference to FIG. 5A, one embodiment of a mobile computing device 500 for implementing the embodiments is illustrated. In a basic configuration, the mobile computing device 500 is a handheld computer having both input elements and output elements. The mobile computing device 500 typically includes a display 505 and one or more input buttons 510 that allow the user to enter information into the mobile computing device 500. The display 505 of the mobile computing device 500 may also function as an input device (e.g., a touch screen display). If included, an optional side input element 515 allows further user input. The side input element 515 may be a rotary switch, a button, or any other type of manual input element. In alternative embodiments, mobile computing device 500 may incorporate more or less input elements. For example, the display 505 may not be a touch screen in some embodiments. In yet another alternative embodiment, the mobile computing device 500 is a portable phone system, such as a cellular phone. The mobile computing device 500 may also include an optional keypad 535. Optional keypad 535 may be a physical keypad or a “soft” keypad generated on the touch screen display. In various embodiments, the output elements include the display 505 for showing a graphical user interface (GUI), a visual indicator 520 (e.g., a light emitting diode), and/or an audio transducer 525 (e.g., a speaker). In some embodiments, the mobile computing device 500 incorporates a vibration transducer for providing the user with tactile feedback. In yet another embodiment, the mobile computing device 500 incorporates input and/or output ports, such as an audio input (e.g., a microphone jack), an audio output (e.g., a headphone jack), and a video output (e.g., a HDMI port) for sending signals to or receiving signals from an external device.

FIG. 5B is a block diagram illustrating the architecture of one embodiment of a mobile computing device. That is, the mobile computing device 500 can incorporate a system (i.e., an architecture) 502 to implement some embodiments. In one embodiment, the system 502 is implemented as a “smart phone” capable of running one or more applications (e.g., browser, e-mail, calendaring, contact managers, messaging clients, games, and media clients/players). In some embodiments, the system 502 is integrated as a computing device, such as an integrated personal digital assistant (PDA) and wireless phone.

One or more application programs 550 may be loaded into the memory 562 and run on or in association with the operating system 564. Examples of the application programs include phone dialer programs, e-mail programs, personal information management (PIM) programs, word processing programs, spreadsheet programs, Internet browser programs, messaging programs, and so forth. The system 502 also includes a non-volatile storage area 568 within the memory 562. The non-volatile storage area 568 may be used to store persistent information that should not be lost if the system 502 is powered down. The application programs 150 may use and store information in the non-volatile storage area 568, such as e-mail or other messages used by an e-mail application, and the like. A synchronization application (not shown) also resides on the system 502 and is programmed to interact with a corresponding synchronization application resident on a host computer to keep the information stored in the non-volatile storage area 568 synchronized with corresponding information stored at the host computer. As should be appreciated, other applications may be loaded into the memory 562 and run on the mobile computing device 500.

The system 502 has a power supply 570, which may be implemented as one or more batteries. The power supply 570 might further include an external power source, such as an AC adapter or a powered docking cradle that supplements or recharges the batteries.

The system 502 may also include a radio 572 that performs the function of transmitting and receiving radio frequency communications. The radio 572 facilitates wireless connectivity between the system 502 and the “outside world,” via a communications carrier or service provider. Transmissions to and from the radio 572 are conducted under control of the operating system 564. In other words, communications received by the radio 572 may be disseminated to the application programs 150 via the operating system 564, and vice versa.

The visual indicator 520 may be used to provide visual notifications and/or an audio interface 574 may be used for producing audible notifications via the audio transducer 525. In the illustrated embodiment, the visual indicator 520 is a light emitting diode (LED) and the audio transducer 525 is a speaker. These devices may be directly coupled to the power supply 570 so that when activated, they remain on for a duration dictated by the notification mechanism even though the processor 560 and other components might shut down for conserving battery power. The LED may be programmed to remain on indefinitely until the user takes action to indicate the powered-on status of the device. The audio interface 574 is used to provide audible signals to and receive audible signals from the user. For example, in addition to being coupled to the audio transducer 525, the audio interface 574 may also be coupled to a microphone to receive audible input, such as to facilitate a telephone conversation. In accordance with embodiments of the present invention, the microphone may also serve as an audio sensor to facilitate control of notifications, as will be described below. The system 502 may further include a video interface 576 that enables an operation of an on-board camera 530 to record still images, video stream, and the like.

A mobile computing device 500 implementing the system 502 may have additional features or functionality. For example, the mobile computing device 500 may also include additional data storage devices (removable and/or non-removable) such as, magnetic disks, optical disks, or tape. Such additional storage is illustrated in FIG. 5B by the non-volatile storage area 568.

Data/information generated or captured by the mobile computing device 500 and stored via the system 502 may be stored locally on the mobile computing device 500, as described above, or the data may be stored on any number of storage media that may be accessed by the device via the radio 572 or via a wired connection between the mobile computing device 500 and a separate computing device associated with the mobile computing device 500, for example, a server computer in a distributed computing network, such as the Internet. As should be appreciated such data/information may be accessed via the mobile computing device 500 via the radio 572 or via a distributed computing network. Similarly, such data/information may be readily transferred between computing devices for storage and use according to well-known data/information transfer and storage means, including electronic mail and collaborative data/information sharing systems.

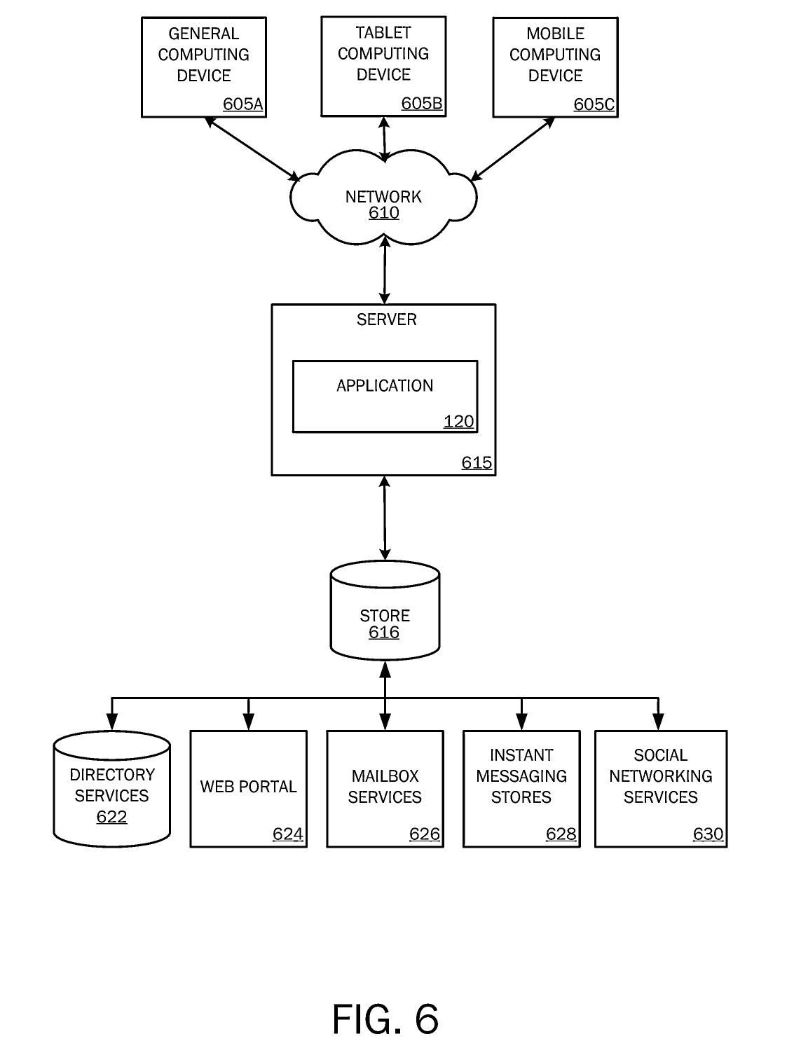

FIG. 6 illustrates one embodiment of the architecture of a system for providing an activity stream across multiple workloads, as described above. Content developed, interacted with, or edited in association with the application 120 may be stored in different communication channels or other storage types. For example, various documents may be stored using a directory service 622, a web portal 624, a mailbox service 626, an instant messaging store 628, or a social networking service 630. The application 120 may use any of these types of systems or the like for providing an activity stream across multiple workloads, as described herein. A server 615 may provide the application 120 to clients 118. As one example, the server 615 may be a web server providing the application 120 over the web. The server 615 may provide the application 120 over the web to clients 118 through a network 610. By way of example, the client computing device 118 may be implemented and embodied in a personal computer 605A, a tablet computing device 605B and/or a mobile computing device 605C (e.g., a smart phone), or other computing device. Any of these embodiments of the client computing device may obtain content from the store 616.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claimed invention.

We claim:

1. A method for providing an activity stream, the method comprising:
receiving activity data associated with an individual or group from a plurality of information sources;
storing the activity data from the plurality of information sources in a graph;
receiving an indication of a selection to view an activity stream associated with the individual or group; and
providing an activity stream comprising the stored activity data from the plurality of information sources for display in a user interface.

2. The method of claim 1, wherein providing an activity stream comprising the stored activity data from the plurality of information sources for display in a user interface includes providing the activity stream for display as a timeline view of the activity data.

3. The method of claim 1, wherein storing the activity from the plurality of information sources in a graph further comprises establishing a relationship between the individual or group and an entity upon which the individual or group has acted.

4. The method of claim 3, wherein establishing a relationship between the individual or group and the entity the individual or group has acted upon comprises creating a first node in the graph for the individual or group, a second node for the entity the individual or group has acted upon, and an edge connecting the first node and the second node wherein the edge is an activity performed by the individual or group to the entity.

5. The method of claim 4, further comprising calculating a weight for the edge according to the activity performed.

6. The method of claim 5, further comprising:
ranking a plurality of pieces of activity data according to the calculated edge weights; and
determining one or more pieces of the activity data to display according to the ranking.

7. The method of claim 4, wherein an activity performed by the individual or group comprises one of:
liking an entity;
commenting on an entity;
following an entity;
sharing an entity;
authoring an entity;
modifying an entity;
a communication with an entity; or
participation in a meeting.

8. The method of claim 1, wherein a group comprises one or more of:
a plurality of individuals who share an organizational relationship;
a plurality of individuals assigned to a project group;
a plurality of individuals who share a common interest; or
common attendees of a particular meeting.

9. A system for providing an activity stream, the system comprising:
one or more processors; and
a memory coupled to the one or more processors, the one or more processors operable to:
receive activity data associated with an individual or group from a plurality of information sources;
store the activity data from the plurality of information sources in a graph;
receive an indication of a selection to view an activity stream associated with the individual or group; and
provide an activity stream comprising the stored activity data from the plurality of information sources for display in a user interface.

10. The system of claim 9, wherein in providing an activity stream comprising the stored activity data from the plurality of information sources for display in a user interface, the one or more processors are operable to provide the activity stream for display in a timeline view of activity in the user interface.

11. The system of claim 9, wherein in storing the activity data from the plurality of information sources in a graph, the one or more processors are operable to:
create a first node in the graph for the individual or group;
create a second node for the entity the individual or group has acted upon;
create an edge connecting the first node and the second node, wherein the edge is an activity performed by the individual or group to the entity;
calculate a weight for the edge according to the activity performed; and
rank a plurality of pieces of activity data according to the calculated edge weights, the rank utilized to determine which one or more pieces of the activity data to display according to the ranking of the activity data.

12. The system of claim 11, wherein an activity performed by the individual or group comprises one of:
liking an entity;
commenting on an entity;
following an entity;
sharing an entity;
authoring an entity;
modifying an entity;
a communication with an entity; or
participation in a meeting.

13. The system of claim 9, wherein the plurality of information sources comprises one or more of:
a social networking service;
an enterprise social network service;
an online productivity software service;
a collaboration service; or
a communication software.

14. A method for providing an activity stream, the method comprising:
receiving an indication of a selection to view an activity stream associated with an individual or group;
requesting activity data for the individual or group;
receiving an activity stream comprising activity data from a plurality of information sources associated with the individual or group;
generating a user interface for displaying the activity stream; and
displaying the activity stream in the user interface.

15. The method of claim 14, wherein displaying the activity stream in the user interface comprises displaying the activity stream in a timeline view of activity.

16. The method of claim 14, wherein displaying the activity stream in the user interface comprises displaying an activity performed by the individual or group and an entity upon which an action was performed.

17. The method of claim 16, wherein displaying an activity performed by the individual or group comprises displaying one or more of:
liking an entity;
commenting on an entity;
following an entity;
sharing an entity;
authoring an entity;
modifying an entity;
a communication with an entity; or
participation in a meeting.

18. The method of claim 16, further comprising:
receiving an indication of a selection of an entity upon which an action was performed; and
providing connectivity to the selected entity via an appropriate application for the selected entity.

19. The method of claim 16, wherein a group comprises one or more of:
a plurality of individuals who share an organizational relationship;
a plurality of individuals assigned to a project group;
a plurality of individuals who share a common interest; or
common attendees of a particular meeting.

20. The method of claim 19, further comprising:
receiving an indication of a selection of an individual or group sharing an organizational relationship with the individual or group;
requesting activity data for the individual or group sharing an organizational relationship with the individual or group;
receiving an activity stream comprising activity data from a plurality of information sources associated with the individual or group sharing an organizational relationship with the individual or group;
generating a user interface for displaying the activity stream; and
displaying the activity stream in the user interface.
